(19) United States
(12) Patent Application Publication
(10) Pub. No.: US 2024/0401946 A1
(43) Pub. Date: Dec. 5, 2024

(54) RANGE FINDING BINOCULAR TELESCOPE

(71) Applicant: SHENZHEN RUIERXING ELECTRONIC CO., LTD, Shenzhen (CN)

(72) Inventors: Luxin Fu, Shenzhen (CN); Zhicheng Xing, Shenzhen (CN)

(21) Appl. No.: 18/801,853

(22) Filed: Aug. 13, 2024

Related U.S. Application Data
(63) Continuation of application No. 18/200,486, filed on May 22, 2023, now Pat. No. 12,072,207.

(51) Int. Cl. G01C 3/04; G02B 23/04; G02B 23/18

(52) U.S. Cl. CPC G01C 3/04; G02B 23/04; G02B 23/18

(57) ABSTRACT

A range finding binocular telescope comprising a first lens body and a second lens body, the first lens body and the second lens body rotating about a central shaft, wherein the first lens body comprises a first lens tube, and a first eyepiece group and a laser transmitting module disposed in the first lens tube, the second lens body comprises a second lens tube, and a second eyepiece group and a laser receiving module disposed in the second lens tube, the laser transmitting module is arranged in front of the first eyepiece group, the laser receiving module is arranged in front of the second eyepiece group, a laser light path for range finding is separated from an observing light path, and the laser light path and the observing light path is capable of being independently adjusted.

### CROSS-REFERENCE TO RELATED APPLICATIONS

The present application is a Continuation Application of U.S. patent application Ser. No. 18/200,486, entitled “RANGE FINDING BINOCULAR TELESCOPE” filed on May 22, 2023, which claims the priority of Chinese Patent Application No. 202310384130.9, filed on Apr. 7, 2023, the entire contents of which are hereby incorporated by reference.

### TECHNICAL FIELD

The present invention relates to the field of photoelectric technology, and particularly to a range finding binocular telescope.

### DESCRIPTION OF THE PRIOR ART

In a typical range finding binocular telescope, a laser transmitting path and a laser receiving path for laser distance measuring are mixed in a prism group. The laser transmitting path and laser receiving path pass through too many surfaces via the prism group, resulting in a significant decrease in laser power. When an object at long-distance is measured, it is necessary to increase laser power. However, the increased laser power increases a risk of laser path leakage to the eyepiece group due to the laser transmitting path mixed in the prism group; moreover, adjustments of the typical range finding binocular telescope are too complicated due to the mixing of the laser path and observation light path.

### SUMMARY OF THE DISCLOSURE

In view of the above, the present invention provides a range finding binocular telescope capable of solving or optimizing the above problems.

The present invention provides a range finding binocular telescope comprising a first lens body and a second lens body, the first lens body and the second lens body rotating about a central shaft, wherein the first lens body comprises a first lens tube, and a first eyepiece group and a laser transmitting module disposed in the first lens tube, the second lens body comprises a second lens tube, and a second eyepiece group and a laser receiving module disposed in the second lens tube, the laser transmitting module is arranged in front of the first eyepiece group, the laser receiving module is arranged in front of the second eyepiece group, a first prism group is provided between the first eyepiece group and the laser transmitting module, a second prism group is provided between the second eyepiece group and the laser receiving module, a laser light path for range finding is separated from an observing light path in front of the first prism group and the second prism group, and the laser light path and the observing light path are adjustable independently; wherein the laser transmitting module comprises a laser transmitting unit; the laser transmitting unit comprises a laser emitter for transmitting laser beams, a collimating lens for collimating the emitted laser beams, a first laser mirror for reflecting the collimated laser beams, a first dichroic mirror for reflecting laser light and allowing natural light to pass therethrough, and a first convex lens for focusing; wherein the laser receiving module comprises a laser receiving unit; the laser receiving unit comprises a second convex lens for focusing, a second dichroic mirror for reflecting the laser beams turned back from the target and allowing natural light to pass therethrough, a second laser mirror for reflecting the reflected laser beams from the second dichroic mirror, a laser receiving coupling lens for receiving and focusing the laser beams reflected by the second laser mirror, and a laser receiver for receiving the focused laser beams; wherein the laser beams emitted to the target by the laser transmitting module and light in the observing light path band are focused by the second convex lens and then projected onto the second dichroic mirror in the laser receiving module, and a coating film of the first dichroic mirror transmits light of normal observing light path band to the first prism group at a rear end, and a coating film of the second dichroic mirror transmits the light of the normal observing light path band to the second prism group at a rear end, and laser light of a specific wavelength band of a laser transmitting is reflected toward the second laser mirror, and the second laser mirror projects the received laser light toward the laser receiver.

In some embodiments, the laser transmitting module is mounted in the first lens tube through a laser transmitting module ball head, and the laser transmitting module comprises a laser transmitting module base, the laser transmitting unit is mounted in the laser transmitting module base.

In some embodiments, the collimating lens is mounted in a first focal length adjusting member, and the first focal length adjusting member is mounted on the laser transmitting module base.

In some embodiments, the collimating lens is positioned in front of the laser emitter to form a laser transmitting group, and the first laser mirror and the first dichroic mirror are opposed to each other to form a laser guiding group, and the laser guiding group is arranged in front of the laser transmitting group.

In some embodiments, the laser emitter, the collimating lens, the first laser mirror, and the first dichroic mirror are mounted inside a rear end of the laser transmitting module base, and the first convex lens is mounted inside a front end of the laser transmitting module base.

In some embodiments, the laser transmitting module base is provided with the laser transmitting module ball head protruding outward at an outer side corresponding to a position of the first convex lens.

In some embodiments, the laser transmitting module base is mounted in the first lens body through a laser transmitting module ball head ring.

In some embodiments, the laser receiving module is mounted in the second lens tube through a laser receiving module ball head, and the laser receiving module comprises a laser receiving module base, the laser receiving unit is mounted in the laser receiving module base.

In some embodiments, the laser receiving coupling lens is mounted in a second focal length adjusting member, and the second focal length adjusting member is mounted on the laser receiving module base.

In some embodiments, the laser receiving coupling lens is positioned in front of the laser receiver to constitute a laser receiving group, and the second laser mirror and the second dichroic mirror are opposed to each other to constitute a laser guiding group, wherein the laser guiding group is arranged in front of the laser receiving group.

In some embodiments, the second dichroic mirror, the second laser mirror, the laser receiving coupling lens, and the laser receiver are mounted inside a rear end of the laser receiving module base, and the second convex lens is mounted inside a front end of the laser receiving module base.

In some embodiments, the laser receiving module base is provided with the laser receiving module ball head protruding outward at an outer side corresponding to a position of the second convex lens.

In some embodiments, the laser receiving module base is mounted in the second lens body through a laser receiving module ball head ring.

In some embodiments, the first prism group is mounted in a first prism group ball head and is mounted on the first lens body through a first prism group ball head ring, and the second prism group is mount in a second prism group ball head and is mounted in the second lens body through a second prism group ball head ring.

In some embodiments, a plane where the first laser mirror is located is parallel to a plane where the first dichroic mirror is located.

In some embodiments, a plane where the second laser mirror is located is parallel to a plane where the second dichroic mirror is located.

In some embodiments, the laser emitter and the first laser mirror are arranged opposite to each other in an inner wall of the first lens tube; the first dichroic mirror is between the laser emitter and the first laser mirror; the laser receiver and the second laser mirror are arranged opposite each other in an inner wall of the second lens tube; the second dichroic mirror is between the laser emitter and the second laser mirror.

In some embodiments, the laser transmitting unit further comprises a third laser mirror, the laser beams emitted by the laser emitter sequentially pass through the first laser mirror, the third laser mirror, and the first dichroic mirror, and then are emitted from the first convex lens to reach the target.

In some embodiments, a plane where the third laser mirror is located is parallel to a plane where the first dichroic mirror is located.

In some embodiments, the laser receiving unit further comprises a fourth laser mirror, and the laser beams reflected by the target pass through the second convex lens, sequentially are reflected by the second dichroic mirror, the fourth laser mirror and the second laser mirror, and then are received by the laser receiver.

Compared with the prior art, the advantageous effects of the present invention are that:

In the present invention, the laser receiving and transmitting path and the visual observing light path are separated into two independent systems, and after the laser light path and the observing light path are separated, the total laser power of the laser light path is higher under the same laser transmitting power.

In the present invention, the number of reflect surfaces through which the laser transmitting and receiving paths are separated is reduce, the laser power is improved, and the risk of leakage of the laser light paths to the observing light paths is reduced after the laser light paths are separated.

3. After the laser light path and the observing light path are independent, the adjustment of the laser light path and the observing light path are divided into two independent systems, and the two systems can move independently to reduce the adjustment difficulty so that adjustment in a production link is greatly simplified.

### BRIEF DESCRIPTION OF DRAWINGS

FIG. 1 shows a perspective view of a range finding binocular telescope according to a first embodiment of the present invention.

FIG. 2 shows a schematic plan view of the range finding binocular telescope shown in FIG. 1.

FIG. 3 shows a cross-sectional view along line A-A of the range finding binocular telescope shown in FIG. 2.

FIG. 4 shows a schematic plan view of a laser transmitting path and a laser receiving path of the range finding binocular telescope shown in FIG. 1.

FIG. 5 shows a schematic plan view of a range finding binocular telescope according to a second embodiment of the present invention.

FIG. 6 shows a cross-sectional view along line I-I of the range finding binocular telescope in FIG. 5.

FIG. 7 shows a cross-sectional view along line D-D of the range finding binocular telescope shown in FIG. 5.

FIG. 8 shows a schematic plan view of a range finding binocular telescope according to a third embodiment of the present invention.

FIG. 9 shows a schematic plan view of a laser transmitting path and a laser receiving path of the range finding binocular telescope shown in FIG. 8.

Reference numerals: 1—range finding binocular telescope; 2—first lens body; 20—first lens tube; 21—first eyepiece group; 22—laser transmitting module; 221—laser emitter; 222—first focal length adjusting member; 223—collimating lens; 224—first dichroic mirror; 225—first laser mirror; 225′—third laser mirror; 226—laser transmitting module base; 227—laser transmitting module ball head; 228—first convex lens; 229—laser transmitting module ball head ring; 220—laser transmitting path; 23—display group; 24—first prism group; 241—first prism group ball head ring; 242—first prism group ball head; 3—second lens body; 30—second lens tube; 31—second eyepiece group; 32—laser receiving module; 321—laser receiver; 322—second focal length adjusting member; 323—laser receiving coupling lens; 324—second dichroic mirror; 325—second laser mirror; 325′—fourth laser mirror; 326—laser receiving module base; 327—laser receiving module ball head; 328—second convex lens; 329—laser receiving module ball head ring; 320—laser receiving path; 34—second prism group; 341—second prism group ball head ring; 342—second prism group ball head; 4—central shaft; 40—sleeve.

### DESCRIPTION OF EMBODIMENTS

In order to facilitate understanding of the present invention, the present invention will now be described more fully with reference to the drawings. One or more embodiments of the present invention are shown by way of example in the drawings, in order to provide a more accurate and thorough understanding of the disclosed technical solution. However, it should be understood that the present invention may be realized in many different forms and is not limited to the embodiments described below.

### Embodiment 1

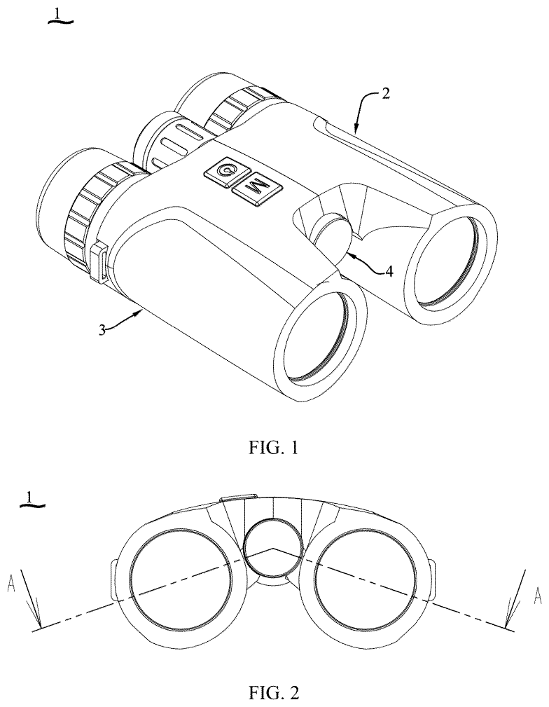

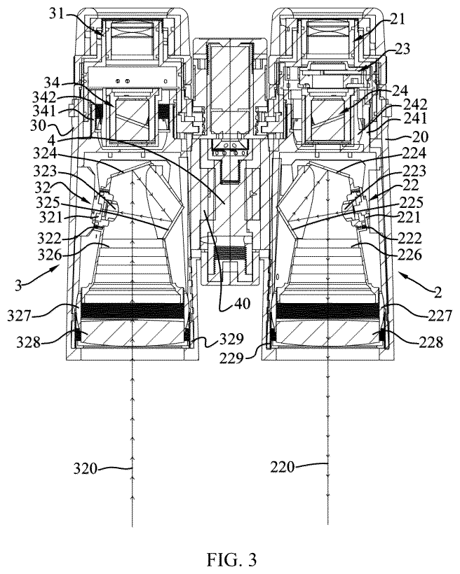

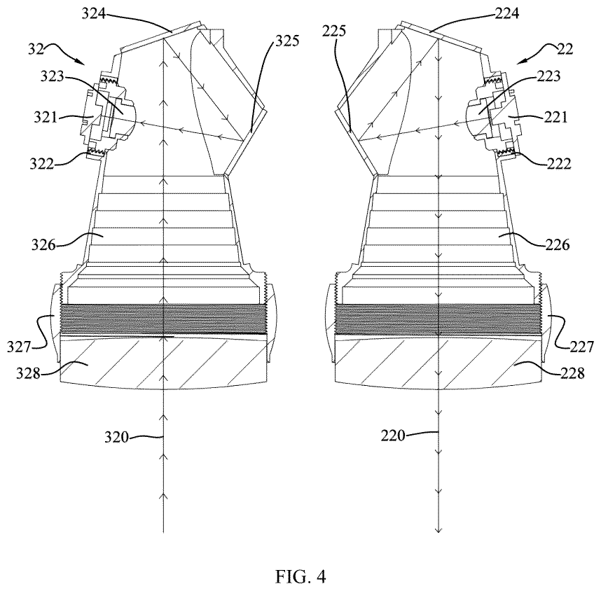

Referring also to FIGS. 1 to 3, a range finding binocular telescope 1 according to an embodiment of the present invention includes a first lens body 2 and a second lens body 3, wherein the first lens body 2 and the second lens body 3 rotate about a central shaft 4. The central shaft 4 is sleeved with a sleeve 40. Preferably, the sleeve 40 is mounted on the second lens body 3, the second lens body 3 and the first lens body 2 are connected with each other through the central shaft 4 to form a left-right lens structure of the binocular telescope, in which the first lens body 2 is a relatively fixed member, and the second lens body 3 is rotated around the first lens body 2 through the central shaft 4. Rotation of the first lens body 2 and the second lens body 3 about the central shaft 4 produces a unique focal point at a specific focal length. In the first lens body 2, a laser transmitting path can be adjusted by rotating and swinging to coincide with the unique focal point on the specific focal length. Similarly, a laser receiving path can also coincide with the focal point. In this way, a distance measuring operation is still possible when the binocular telescope 1 perform a pupil distance adjustment.

In this embodiment, the first lens body 2 includes a first lens tube 20, and a first eyepiece group 21 and a laser transmitting module 22 disposed in the first lens tube 20. The second lens body 3 includes a second lens tube 30, and a second eyepiece group 31 and a laser receiving module 32 disposed in the second lens tube 30. The laser transmitting module 22 is configured to emit desired laser beams and transmit the laser beams to a target. The laser receiving module 32 is configured to receive the laser beams reflected from the target.

In this embodiment, the laser transmitting module 22 is mounted in the first lens tube 20 with a laser transmitting module ball head 227. The laser transmitting module 22 includes a laser transmitting module base 226 and a laser transmitting unit mounted in the laser transmitting module base 226. The laser transmitting module base 226 is hollow. In the description of orientation herein, a direction adjacent/toward the target is defined as forward and a direction away from the target is defined as rearward.

The laser transmitting unit includes a laser emitter 221 for transmitting laser beams, a collimating lens 223 for collimating the emitted laser beams, a first laser mirror 225 for reflecting the collimated laser beams, a first dichroic mirror 224 for reflecting laser light and allowing natural light to pass therethrough, and a first convex lens 228 for focusing. The laser emitter 221, the collimating lens 223, the first laser mirror 225, and the first dichroic mirror 224 of the laser transmitting unit are mounted inside a rear end of the laser transmitting module base 226, and the first convex lens 228 is mounted inside a front end of the laser transmitting module base 226. Preferably, the laser transmitting module base 226 is provided with a laser transmitting module ball head 227 protruding outward at an outer side corresponding to a position of the first convex lens 228. The first convex lens 228 (or convex lens group) is bonded to the laser transmitting module ball head 227. The collimating lens 223 is mounted in a first focal length adjusting member 222 mounted on the laser transmitting module base 226. A focal length of a laser emission can be finely adjusted by threads of the first focal length adjusting member 222 and the laser transmitting module base 226. The collimating lens 223 is positioned in front of the laser emitter 221 to form a laser transmitting group, and the first laser mirror 225 and the first dichroic mirror 224 are opposed to each other to form a laser guiding group. The laser guiding group is arranged in front of the laser transmitting group. In the embodiment, the first laser mirror 225 is capable of totally reflecting the laser beams. The laser light emitted from the laser emitter 221 is collimated by the collimating lens 223, reaches the first laser mirror 225 and is reflected by the first laser mirror 225, and reaches the first dichroic mirror 224, and then is reflected again to pass through the first convex lens 228 to reach the target. Alternatively, the optical path formed by the first dichroic mirror and the first laser mirror may be replaced by using only the first dichroic mirror to form the laser reflecting optical path; alternatively, the optical path formed by the first dichroic mirror and the first laser mirror may be replaced by a prism.

The laser emitter 221 directs laser light through the collimating lens 223 to the first laser mirror 225, and the first laser mirror 225 reflects the laser light to the first dichroic mirror 224 which adopts narrow-band coating film and can reflect 99% of the laser light of the specified wavelength of the laser emitter 221 to the first convex lens 228 or the convex lens group, the laser light is converged to the target through the first convex lens 228 or the convex lens group, wherein the total focal length can be adjusted by the threads on the laser transmitting module ball head 227 and the threads on the laser transmitting module base 226. Now, a lase transmitting path 220 is created. The laser transmitting path 220 is mounted in the first lens body 2 through a laser transmitting module ball head ring 229, and the laser transmitting path 220 can be rotated and swung in the first lens body 2.

In this embodiment, the laser receiving module 32 is mounted in the second lens tube 30 through a laser receiving module ball head 327. The laser receiving module 32 includes a laser receiving module base 326 and a laser receiving unit mounted in the laser receiving module base 326. The laser receiving module base 326 is hollow.

The laser receiving unit includes a second convex lens 328 for focusing, a second dichroic mirror 324 for reflecting the laser beams turned back from the target and allowing natural light to pass therethrough, a second laser mirror 325 for reflecting the reflected laser beams from the second dichroic mirror 324, a laser receiving coupling lens 323 for receiving and focusing the reflected laser beams from the second laser mirror 325, and a laser receiver 321 for receiving the focused laser beams. The second dichroic mirror 324, the second laser mirror 325, the laser receiving coupling lens 323, and the laser receiver 321 of the laser receiving unit are mounted inside a rear end of the laser receiving module base 326, and the second convex lens 328 is mounted inside a front end of the laser receiving module base 326. Preferably, the laser receiving module base 326 is provided with a laser receiving module ball head 327 protruding outward at an outer side corresponding to a position of the second convex lens 328. The second convex lens 328 (or convex lens group) is bonded to the laser receiving module ball head 327. In the first eyepiece group 21, a focus adjusting hand wheel drives an eyepiece adjusting mechanism to move the first eyepiece group 21 and the first convex lens 228 (or convex lens group) to generate a focus movement, and in the second eyepiece group 31, a focus adjusting hand wheel drives the eyepiece adjusting mechanism to move the second eyepiece lens group 31 and the second convex lens 328 (or convex lens group) to generate a focus movement, observing light path after the change of the total focal length allows a user to view objects at close and distant distances.

In the embodiment, the laser receiver 321 converts the received optical signal into an electrical signal. The laser light emitted by the laser transmitting unit is reflected by the target, focused by the laser receiving coupling lens 323, and reaches the laser receiver 232. The laser receiving coupling lens 323 is mounted in a second focal length adjusting member 322 mounted on the laser receiving module base 326, wherein the focal length of the laser receiving can be finely adjusted by the threads of the second focal length adjusting member 322 and the laser receiving module base 326. The laser receiving coupling lens 323 is positioned in front of the laser receiver 321 to constitute a laser receiving group, and the second laser mirror 325 and the second dichroic mirror 324 are opposed to each other to constitute a laser guiding group, wherein the laser guiding group is arranged in front of the laser receiving group. In this embodiment, the second laser mirror 325 is capable of totally reflecting the laser beams. The laser light reflected by the target passes through the second convex lens 328, reaches the second dichroic mirror 324, is reflected by the second laser mirror 325, and then reaches the laser receiving coupling lens 323, and finally, the laser receiver 321 receives the laser light. Thereby, a laser receiving path 320 is generated.

Specifically, the laser transmitting path 220 emits laser light to the target, and the laser light reflected from the target passes through the second convex lens 328 and reaches the second dichroic mirror 324 which adopts narrow-band coating film and can reflect 99% of the laser light of the specified wavelength of the laser emitter 221 to the second laser mirror 325, and then converge the laser light to be received by the laser receiver 321 through the laser receiving coupling lens 323, wherein the total focal length can be adjusted by threads on the laser receiving module ball head 327 and the laser receiving module base 326. Now, the laser receiving path 320 is generated. The laser receiving path 320 is mounted in the second lens body 3 through the laser receiving module ball head ring 329, and the laser receiving path 320 can be rotated and swung in the second lens body 3.

Preferably, the first dichroic mirror 224 and the second dichroic mirror 324 are coated in the same manner, and both have the function of reflecting as many specific wavelength band lasers as possible to participate in the ranging work. In the embodiment, the laser receiving path 320 converges the laser light emitted to the target by the laser transmitting path 220 and the light in the normal observing light path band through the second convex lens 328 or the convex lens group, and then projects the converged light to the second dichroic mirror 324. At this time, the coating film of the first dichroic mirror 224 transmits wavelength band 450 nm to 750 nm of the normal observing light path to the first prism group 24 at the rear end, and the coating film of the second dichroic mirror 324 transmits the wavelength band 450 nm to 750 nm of the normal observing light path to the second prism group 34 at the rear end. The laser light of the specific wavelength band of the laser emitter 221 is reflect to the second laser mirror 325, and the second laser mirror 325 projects the received laser light toward the laser receiver 321. At this time, separate laser transmitting path 220 and laser receiving path 320 are generated.

All light except for the specific wavelength band laser light is transmitted to the first prism group 24 and the second prism group 34, thereby separating a laser ranging optical path in front of the prism group. In other words, the laser light path for range finding is separated in front of the first prism group 24 and the second prism group 34, and the laser light path and the observing light path can be independently adjusted. Preferably, the first prism group 24 and the second prism group 34 have the same configuration.

In this embodiment, the first prism group 24 is mount in a first prism group ball head 242, and then is mounted in the first lens body 2 by a first prism group ball head ring 241. The second prism group 34 is mounted in the second prism group ball 342, and then is mounted in the second lens body 3 by a second prism group ball head ring 341. The first prism group ball head 242 can be rotated and swung in the first lens body 2, and the second prism group ball head 342 can be rotated and swung in the second lens body 3. When the first lens body 2 and the second lens body 3 are rotated about the central shaft 4, convergence and divergence, that is, a focus shift, occur for the observing light path. The first prism group ball head 242 and the second prism group ball head 342 can be rotated and swung to adjust the convergence and divergence of the observing light path so that focal points of the observing light path coincide. The observing light path adjusted by the first prism group 24 and the second prism group 34 is imaged in eyes through the first eyepiece group 21 and the second eyepiece group 31.

A display groups 23 is mounted on specific focal points of the first eyepiece group 21 and the second eyepiece group 31, respectively. In the embodiment, the display group 23 is mounted on a specific focal point of the first eyepiece group 21 or the second eyepiece group 31 so that a ranging center and ranging data can be displayed in the eyes together with the observing image, and a center of the display group 23 can be rotated and moved in the corresponding first lens body 2 and second lens body 3, so that the laser transmitting path 220 can be coincided with a center in the observing light path, that is, the center of the display group 23 coincides with the center of the laser transmitting path 220. Preferably, the display group 23 is a liquid crystal display group. As an eyesight of user is not uniform, a vision adjusting hand wheel can drive a vision adjusting mechanism to move the focal length of the eyepiece group and the liquid crystal display group, so that the visibility can also be adjusted appropriately to the user's eyes.

### Embodiment 2

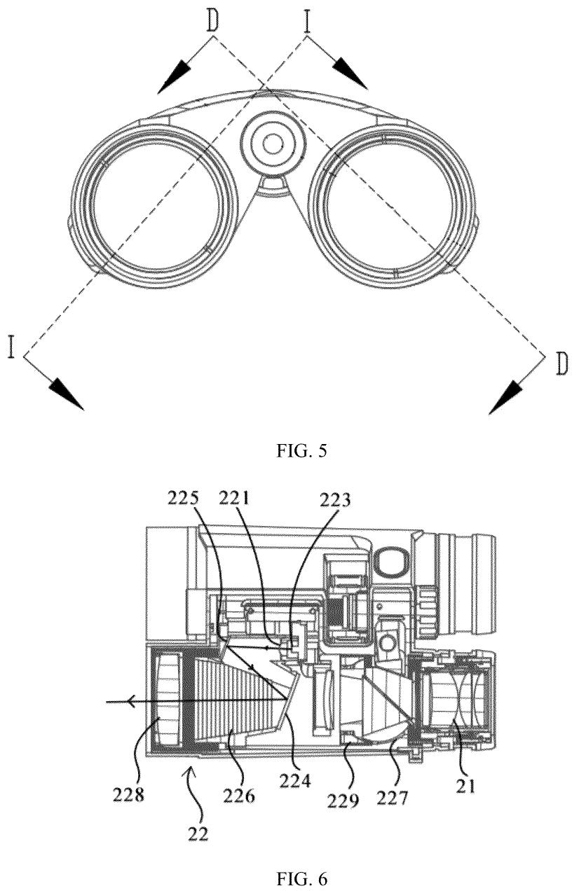

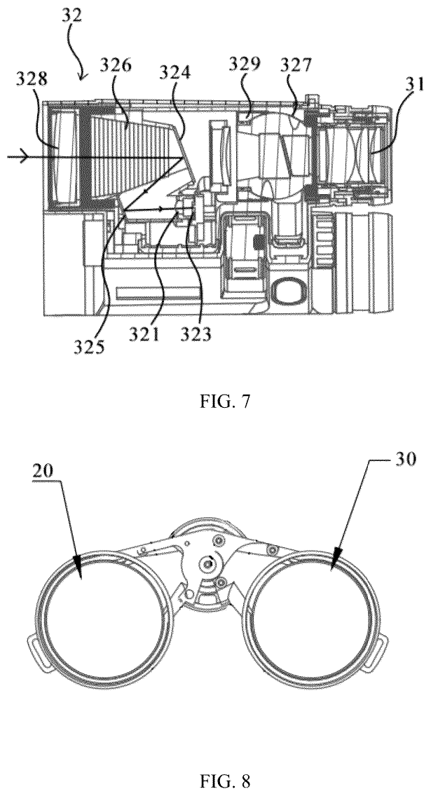

Referring to FIG. 5 to 7, the laser transmitting module 22 includes a laser transmitting module base 226 and a laser transmitting unit mounted in the laser transmitting module base 226. The laser transmitting unit includes a laser emitter 221 for transmitting laser beams, a collimating lens 223 for collimating the emitted laser beams, a first laser mirror 225 for reflecting the collimated laser beams, a first dichroic mirror 224 for reflecting laser light and allowing natural light to pass therethrough, and a first convex lens 228 for focusing.

The laser transmitting module base 226 is hollow, located inside the first lens tube 20, adjacent to the first convex lens 228 (which is an objective lens group), and approximately coaxial with the first lens tube 20. The laser emitter 221, the first laser mirror 225, and the first dichroic mirror 224 are installed in an inner rear end of the laser transmitting module base 226. In the description of orientation herein, a direction adjacent/toward the target is defined as forward and a direction away from the target is defined as rearward.

Specifically, the first dichroic mirror 224 is located at the axial end of the laser transmitting module base 226 away from the first convex lens 228. The first laser mirror 225 and the first dichroic mirror 224 are arranged opposite each other to guide the laser beams emitted by the laser emitter 221. In an axial direction, the first laser mirror 225 is located between the first dichroic mirror 224 and the first convex lens 228. The laser emitter 221 and the first laser mirror 225 are arranged along the axial direction. An emitting head of laser emitter 221 is facing the first laser mirror 225. The collimating lens 223 is set in front of the laser emitter 221 and is located adjacent to the laser emitter 221. In this embodiment, the laser light emitted from the laser emitter 221 is collimated by the collimating lens 223, reaches the first laser mirror 225 and is reflected by the first laser mirror 225, and reaches the first dichroic mirror 224, and then is reflected again to pass through the first convex lens 228 to reach the target, forming a laser emission path.

In this embodiment, the laser beams emitted by the laser emitter 221 propagate along the axial direction, and a plane where the first laser mirror 225 is located is set at a certain angle to a plane where the first convex lens 228 is located. Preferably, a plane where the first dichroic mirror 224 is located is parallel to the plane where the first laser reflector 225 is located, so that the laser beams emitted by the laser emitter 221 can be emitted along the axial direction from the first barrel 20 after two reflections.

The laser receiving unit of the laser receiving module 32 includes a second convex lens 328 for focusing, a second dichroic mirror 324 for reflecting the laser beams turned back from the target and allowing natural light to pass therethrough, a second laser mirror 325 for reflecting the reflected laser beams from the second dichroic mirror 324, a laser receiving coupling lens 323 for receiving and focusing the reflected laser beams from the second laser mirror 325, and a laser receiver 321 for receiving the focused laser beams.

The laser receiving module base 326 is hollow, located inside the second lens tube 30, adjacent to the second convex lens 328 (which is an objective lens group), and approximately coaxial with the second lens tube 30. The laser receiver 321, the second laser mirror 325, and the second dichroic mirror 324 are installed in an inner rear end of the laser receiving module base 326. The second dichroic mirror 324 is located at an axial end of the laser receiving module base 326 away from the second convex lens 328. The second laser mirror 325 and the second dichroic mirror 324 are arranged opposite each other to guide the received laser beams. In the axial direction, the second laser mirror 325 is between the second dichroic mirror 324 and the second convex lens 328. The laser receiver 321 and the second laser mirror 325 are arranged along the axial direction. A receiving head of the laser receiver 321 is facing the second laser mirror 325. The laser receiving coupling lens 323 is set in front of the laser receiver 321 and adjacent to the laser receiver 321. The laser beams emitted by the laser emitter 221 will be reflected again by the target. The laser light reflected by the target passes through the second convex lens 328, reaches the second dichroic mirror 324, is reflected by the second laser mirror 325, and then reaches the laser receiving coupling lens 323, and finally, the laser receiver 321 receives the laser light. Thereby, a laser receiving path is generated.

In this embodiment, the laser beams reflected by the target enters the second lens tube 30 along the axial direction. Therefore, a plane where the second dichroic mirror 324 is located is set at a certain angle to a plane where the second convex lens 328 is located, and a plane where the second laser mirror 325 is located is parallel to the plane where the second dichroic mirror 324 is located, so that the laser beams reflected by the target can reach the laser receiver 321 after two reflections.

### Embodiment 3

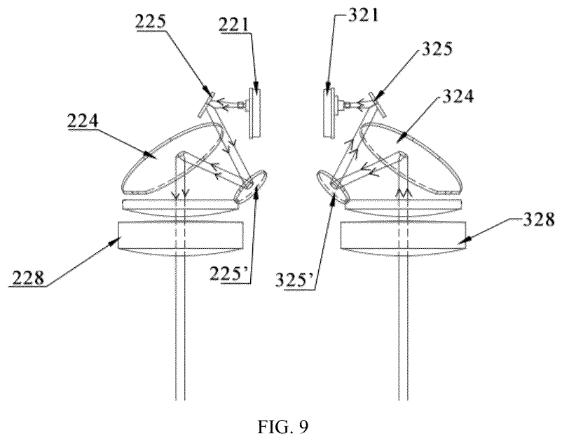

FIGS. 8 and 9 show a range finding binocular telescope according to a third embodiment of the present invention. In this embodiment, the laser transmitting unit of the laser transmitting module base 226 includes a laser emitter 221 for transmitting laser beams, a first dichroic mirror 224 for reflecting laser light and allowing natural light to pass therethrough, at least two laser mirrors and a first convex lens 228. The laser receiving unit of the laser receiving module 32 includes a laser receiver 321 for receiving the focused laser beams, a second dichroic mirror 324 for reflecting the laser beams turned back from the target and allowing natural light to pass therethrough, at least two laser mirrors and a second convex lens 328. The laser beams emitted by the laser emitter 221 are reflected by at least two laser mirrors and the first dichroic mirror 224 in the first lens body 2, and then emitted from the first convex lens 228 (the first convex lens 228 is an objective lens group), and reach the target object. The laser beams reflected by the target pass through the second convex lens 328 (the second convex lens 328 is an objective lens group), and are reflected by the second dichroic mirror 324 and at least two laser mirrors in the second lens body 3, and then received by the laser receiver 321, thereby forming a ranging optical path. Due to the fact that there are at least two laser mirrors in the first mirror body 2 and the second mirror body 3, it is possible to shorten the space required for laser optical path propagation under the same optical path adjustment, effectively reducing the volume of the telescope.

In this embodiment, the at least two laser mirrors in the first lens body 2 include a first laser mirror 225 and a third laser mirror 225′; the at least two laser mirrors in the second lens body 3 include a second laser mirror 325 and a fourth laser mirror 325′. The laser beams emitted by the laser emitter 221 sequentially pass through the first laser mirror 225, the third laser mirror 225′, and the first dichroic mirror 224, and then are emitted from the first convex lens 228, thereby reaching the target. The laser beams reflected by the target sequentially pass through the second convex lens 328 and enters the second barrel 30, and is then reflected by the second dichroic mirror 324, the fourth laser mirror 325′, and the second laser mirror 325, and then are received by the laser receiver 321. In this embodiment, a collimating lens is provided between the laser emitter 221 and the first laser mirror 225 for collimating the emitted laser beams. A laser receiving coupling lens is provided between the laser receiver 321 and the second laser mirror 325 for receiving and converging the laser beams reflected by the second laser mirror 325.

The laser emitter 221 is respectively arranged opposite to the first laser mirror 225 and the third laser mirror 225′, and the third laser mirror 225′ is arranged opposite to the first dichroic mirror 224. Preferably, the first laser mirror 225, the third laser mirror 225′, and the first dichroic mirror 224 are inclined relative to the axial direction. And the first laser mirror 225 is aligned with the laser emitter 221 in a horizontal direction, and the third laser mirror 225′ is roughly aligned with the first dichroic mirror 224 in the horizontal direction. In this embodiment, the sizes of the first laser mirror 225 and the third laser mirror 225′ are both smaller than the size of the first dichroic mirror 224. Preferably, the first laser emitter 221 emits transverse laser beams, so that when the laser beams sequentially pass through the first laser mirror 225, the third laser mirror 225′, and the first dichroic mirror 224, and are reflected along the axial direction of the first lens tube 20 to form a laser emission path. More preferably, a plane where the third laser mirror 225′ is located is parallel to a plane where the first dichroic mirror 224 is located. Similarly, a plane where the fourth laser mirror 325′ is located is parallel to a plane where the second dichroic mirror 324 is located.

The laser receiver 321 is respectively arranged opposite to the second laser mirror 325 and the fourth laser mirror 325′, and the fourth laser mirror 325′ is arranged opposite to the second dichroic mirror 324. Preferably, the second laser mirror 325, the fourth laser mirror 325′, and the second dichroic mirror 324 are inclined relative to the axial direction. And the second laser mirror 325 is aligned with the laser receiver 321 in the horizontal direction, and the fourth laser mirror 325′ is roughly aligned with the second dichroic mirror 324 in the horizontal direction. The laser beams reflected by the target enters into the second lens tube 30 along the axial direction of the second lens tube 30, and are sequentially reflected by the second dichroic mirror 324, the fourth laser mirror 325′, and the second laser mirror 325, and then are received by the laser receiver 321 to form a laser receiving optical path. Preferably, the size of the second laser mirror 325 and the fourth laser mirror 325′ are both smaller than the size of the second dichroic mirror 324.

In the range finding binocular telescope provided by the present invention, the laser optical path and the observing optical path are separated, the total laser power of the laser optical path is higher under the same laser tube emission power; and a risk of the laser light path leaking out to the observing light path is reduced, and adjustment in a production link is greatly simplified.

The above is only preferred embodiments of the present invention, and is not intended to limit the present invention. Any simple change or equivalent replacement of the technical solution that can be easily obtained by any person familiar with the technical field within the technical scope disclosed by the invention falls within the protection scope of the invention.

1. A range finding binocular telescope, comprising: a first lens body and a second lens body, the first lens body and the second lens body rotating about a central shaft, wherein the first lens body comprises a first lens tube, and a first eyepiece group and a laser transmitting module disposed in the first lens tube, the second lens body comprises a second lens tube, and a second eyepiece group and a laser receiving module disposed in the second lens tube, the laser transmitting module is arranged in front of the first eyepiece group, the laser receiving module is arranged in front of the second eyepiece group, a first prism group is provided between the first eyepiece group and the laser transmitting module, a second prism group is provided between the second eyepiece group and the laser receiving module, a laser light path for range finding is separated from an observing light path in front of the first prism group and the second prism group, and the laser light path and the observing light path are adjustable independently;
wherein the laser transmitting module comprises a laser transmitting unit; the laser transmitting unit comprises a laser emitter for transmitting laser beams, a collimating lens for collimating the emitted laser beams, a first laser mirror for reflecting the collimated laser beams, a first dichroic mirror for reflecting laser light and allowing natural light to pass therethrough, and a first convex lens for focusing;
wherein the laser receiving module comprises a laser receiving unit; the laser receiving unit comprises a second convex lens for focusing, a second dichroic mirror for reflecting the laser beams turned back from the target and allowing natural light to pass therethrough, a second laser mirror for reflecting the reflected laser beams from the second dichroic mirror, a laser receiving coupling lens for receiving and focusing the laser beams reflected by the second laser mirror, and a laser receiver for receiving the focused laser beams;
wherein the laser beams emitted to the target by the laser transmitting module and light in the observing light path band are focused by the second convex lens and then projected onto the second dichroic mirror in the laser receiving module, and a coating film of the first dichroic mirror transmits light of normal observing light path band to the first prism group at a rear end, and a coating film of the second dichroic mirror transmits the light of the normal observing light path band to the second prism group at a rear end, and laser light of a specific wavelength band of a laser transmitting is reflected toward the second laser mirror, and the second laser mirror projects the received laser light toward the laser receiver.

2. The range finding binocular telescope according to claim 1, wherein the laser transmitting module is mounted in the first lens tube through a laser transmitting module ball head, and the laser transmitting module comprises a laser transmitting module base, the laser transmitting unit is mounted in the laser transmitting module base.

3. The range finding binocular telescope according to claim 2, wherein the collimating lens is mounted in a first focal length adjusting member, and the first focal length adjusting member is mounted on the laser transmitting module base.

4. The range finding binocular telescope according to claim 2, wherein the collimating lens is positioned in front of the laser emitter to form a laser transmitting group, and the first laser mirror and the first dichroic mirror are opposed to each other to form a laser guiding group, and the laser guiding group is arranged in front of the laser transmitting group.

5. The range finding binocular telescope according to claim 2, wherein the laser emitter, the collimating lens, the first laser mirror, and the first dichroic mirror are mounted inside a rear end of the laser transmitting module base, and the first convex lens is mounted inside a front end of the laser transmitting module base.

6. The range finding binocular telescope according to claim 2, wherein the laser transmitting module base is provided with the laser transmitting module ball head protruding outward at an outer side corresponding to a position of the first convex lens.

7. The range finding binocular telescope according to claim 6, wherein the laser transmitting module base is mounted in the first lens body through a laser transmitting module ball head ring.

8. The range finding binocular telescope according to claim 2, wherein the laser receiving module is mounted in the second lens tube through a laser receiving module ball head, and the laser receiving module comprises a laser receiving module base, the laser receiving unit is mounted in the laser receiving module base.

9. The range finding binocular telescope according to claim 8, wherein the laser receiving coupling lens is mounted in a second focal length adjusting member, and the second focal length adjusting member is mounted on the laser receiving module base.

10. The range finding binocular telescope according to claim 8, wherein the laser receiving coupling lens is positioned in front of the laser receiver to constitute a laser receiving group, and the second laser mirror and the second dichroic mirror are opposed to each other to constitute a laser guiding group, wherein the laser guiding group is arranged in front of the laser receiving group.

11. The range finding binocular telescope according to claim 8, wherein the second dichroic mirror, the second laser mirror, the laser receiving coupling lens, and the laser receiver are mounted inside a rear end of the laser receiving module base, and the second convex lens is mounted inside a front end of the laser receiving module base.

12. The range finding binocular telescope according to claim 8, wherein the laser receiving module base is provided with the laser receiving module ball head protruding outward at an outer side corresponding to a position of the second convex lens.

13. The range finding binocular telescope according to claim 12, wherein the laser receiving module base is mounted in the second lens body through a laser receiving module ball head ring.

14. The range finding binocular telescope according to claim 1, wherein the first prism group is mounted in a first prism group ball head and is mounted on the first lens body through a first prism group ball head ring, and the second prism group is mount in a second prism group ball head and is mounted in the second lens body through a second prism group ball head ring.

15. The range finding binocular telescope according to claim 1, wherein a plane where the first laser mirror is located is parallel to a plane where the first dichroic mirror is located.

16. The range finding binocular telescope according to claim 15, wherein a plane where the second laser mirror is located is parallel to a plane where the second dichroic mirror is located.

17. The range finding binocular telescope according to claim 1, wherein the laser emitter and the first laser mirror are arranged opposite to each other in an inner wall of the first lens tube; the first dichroic mirror is between the laser emitter and the first laser mirror; the laser receiver and the second laser mirror are arranged opposite each other in an inner wall of the second lens tube; the second dichroic mirror is between the laser emitter and the second laser mirror.

18. The range finding binocular telescope according to claim 1, wherein the laser transmitting unit further comprises a third laser mirror, the laser beams emitted by the laser emitter sequentially pass through the first laser mirror, the third laser mirror, and the first dichroic mirror, and then are emitted from the first convex lens to reach the target.

19. The range finding binocular telescope according to claim 18, wherein a plane where the third laser mirror is located is parallel to a plane where the first dichroic mirror is located.

20. The range finding binocular telescope according to claim 1, wherein the laser receiving unit further comprises a fourth laser mirror, and the laser beams reflected by the target pass through the second convex lens, sequentially are reflected by the second dichroic mirror, the fourth laser mirror and the second laser mirror, and then are received by the laser receiver.
